(19) United States
(12) Patent Application Publication
(10) Pub. No.: US 2010/0205540 A1
(43) Pub. Date: Aug. 12, 2010

(54) TECHNIQUES FOR PROVIDING ONE-CLICK ACCESS TO VIRTUAL CONFERENCE EVENTS

(75) Inventors: Amit Gupta, Redmond, WA (US); Avronil Bhattacharjee, Redmond, WA (US); Gurdeep S. Pall, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/368,594

(22) Filed: Feb. 10, 2009

(51) Int. Cl. G06F 3/048

(52) U.S. Cl. 715/753

(57) ABSTRACT

Techniques to provide efficient access to virtual conference events are described. An apparatus may include a virtual conference (VC) server component operative to generate a conference bridge for a bridge owner. The VC server component may provide a link to the conference bridge, and provide access to a virtual conference with the bridge owner via the link. The VC server component may also include a profile module operative to store the conference bridge in a directory profile for the bridge owner. The VC server component may also include a server meeting module operative to create a virtual conference with the bridge owner when the link is accessed. Other embodiments are described and claimed.

### BACKGROUND

A virtual conference system typically allows multiple participants to communicate in a collaborative and real-time meeting over a network, typically via a conference bridge. In this manner various geographically disparate participants may interact and communicate information in a virtual meeting environment similar to a physical meeting environment where all the participants are within one room.

In order to participate in a virtual conference, the meeting organizer must typically provide access information for the conference bridge. When joining the virtual conference, a participant must retrieve the access information, for example from the invitation, or an email message, etc. The participant must then dial the dial-in information, which may include a phone number, an access code, a meeting number, etc. It is with respect to these considerations and others that the present improvements have been made.

### SUMMARY

Various embodiments may be generally directed to virtual conference systems. Some embodiments may be particularly directed to techniques to provide quick access to a virtual conference. Embodiments may provide, for example, “one-click,” “one-button,” “one-touch,” access, or the like. Embodiments may provide a personal conferencing bridge for each user of a conferencing system, and a link that may be used to access the static bridge without requiring the conference participant to remember or lookup access information. The personal conferencing bridge may be provisioned for a user of the virtual conference system, for example, in a directory service, or in a Presence document.

In one embodiment, an apparatus may comprise a virtual conference (VC) server component operative to generate a conference bridge for a bridge owner, provide a link to the conference bridge, and provide access to a virtual conference with the bridge owner via the link. The VC server component may further comprise a profile module operative to store the conference bridge in a directory profile for the bridge owner. The VC server component may still further comprise a server meeting module operative to create a virtual conference with the bridge owner when the link is accessed. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an embodiment of a virtual conference system.

FIG. 2 illustrates an embodiment of a user view.

FIG. 3 illustrates an embodiment of a user view.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to virtual conference systems arranged to provide meeting and collaboration services to multiple participants over a network. Some virtual conference systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other virtual conference systems may be designed to operate for a private network, business, organization, or enterprise, and may utilize a virtual conference server such as MICROSOFT OFFICE COMMUNICATIONS SERVER made by Microsoft Corporation, Redmond, Wash. It may be appreciated, however, that implementations are not limited to these examples.

A virtual conference system may include, among other network elements, a virtual conference server or other processing device arranged to provide web and/or telephonic conferencing services. For example, a virtual conference server may include, among other server elements, a server meeting component operative to control and mix different types of media content for a meeting and collaboration event, such as a web conference. A meeting and collaboration event may refer to any virtual conference event offering various types of virtual information in a real-time or live online environment, and is sometimes referred to herein as simply a “meeting event,” “virtual event” or “virtual conference event.”

In one embodiment, the virtual conference system may further include one or more computing devices implemented as meeting consoles. Each meeting console may be arranged to participate in a virtual event by connecting to the virtual conference server. Different types of media information from the various meeting consoles may be received by the virtual conference server during the virtual event, which in turn distributes the media information to some or all of the other meeting consoles participating in the virtual event As such, any given meeting console may have a display with multiple media content views of different types of media content. In this manner various geographically disparate participants may interact and communicate information in a virtual meeting environment.

Conventional conferencing systems typically require a user to remember or look-up the access information for their conference bridge and provide that information to any invitees to the conference. Those invited to join the conference must usually retrieve the dial-in information, for example, from an email message, or a meeting event in a calendar or scheduling application. Those not initially invited to a meeting may have no way of joining a conference without access to the conference bridge information.

To solve these and other problems, embodiments may implement various enhanced virtual conferencing techniques.

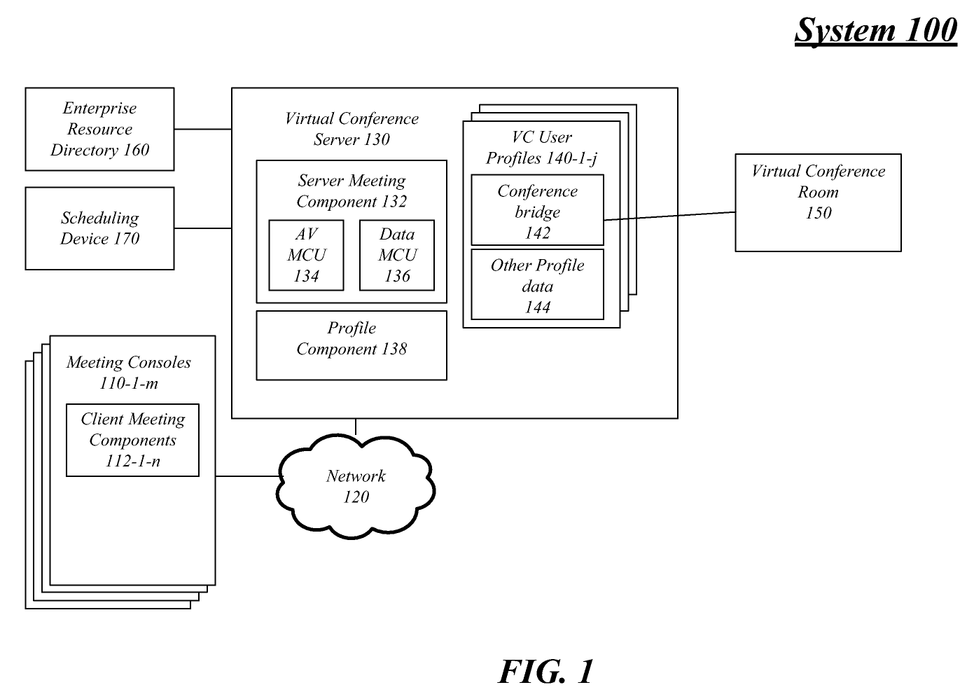

FIG. 1 illustrates a block diagram for a virtual conference system 100. Virtual conference system 100 may represent a general system architecture suitable for implementing various embodiments. Virtual conference system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although virtual conference system 100 as shown in FIG. 1 has a limited number of elements in a certain topology, it may be appreciated that virtual conference system 100 may include more or less elements in alternate topologies as desired for a given implementation. The embodiments are not limited in this context.

In various embodiments, the virtual conference system 100 may comprise, or form part of, a wired communications system, a wireless communications system, or a combination of both. For example, the virtual conference system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The virtual conference system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

In various embodiments, the virtual conference system 100 may be arranged to communicate, manage or process different types of information, such as media information and control information. Examples of media information may generally include any data representing content meant for a user, such as voice information, video information, audio information, image information, textual information, numerical information, application information, alphanumeric symbols, graphics, and so forth. Media information may sometimes be referred to as “media content” as well. Control information may refer to any data representing commands, instructions or control words meant for an automated system. For example, control information may be used to route media information through a system, to establish a connection between devices, instruct a device to process the media information in a predetermined manner, and so forth.

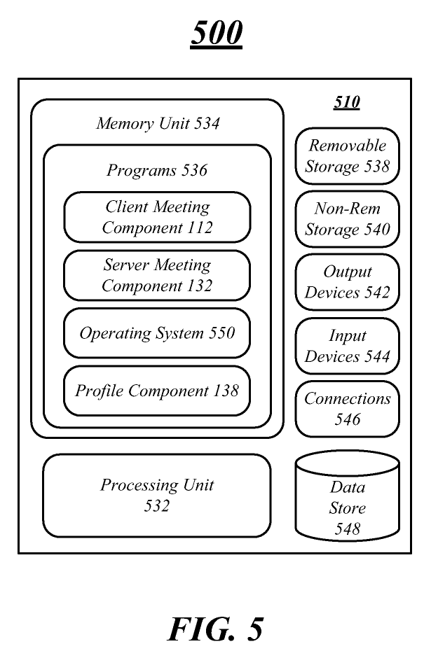

In various embodiments, virtual conference system 100 may include a virtual conference server 130. The virtual conference server 130 may comprise any logical or physical entity that is arranged to establish, manage or control a virtual conference event between meeting consoles 110-1-m over a network 120. Network 120 may comprise, for example, a packet-switched network, a circuit-switched network, or a combination of both. In various embodiments, the virtual conference server 130 may comprise or be implemented as any processing or computing device, such as a computer, a server, a server array or server farm, a work station, a mini-computer, a main frame computer, a supercomputer, and so forth. The virtual conference server 130 may comprise or implement a general or specific computing architecture suitable for communicating and processing virtual information. In one embodiment, for example, the virtual conference server 130 may be implemented using a computing architecture as described with reference to FIG. 5. Examples for the virtual conference server 130 may include without limitation a MICROSOFT OFFICE COMMUNICATIONS SERVER, a MICROSOFT OFFICE LIVE MEETING server, and so forth.

A specific implementation for the virtual conference server 130 may vary depending upon a set of communication protocols or standards to be used for the virtual conference server 130. In one example, the virtual conference server 130 may be implemented in accordance with the Internet Engineering Task Force (IETF) Multiparty Virtual Session Control (MMUSIC) Working Group Session Initiation Protocol (SIP) series of standards and/or variants. SIP is a proposed standard for initiating, modifying, and terminating an interactive user session that involves virtual elements such as video, voice, instant messaging, online games, and virtual reality. In another example, the virtual conference server 130 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. Both the SIP and H.323 standards are essentially signaling protocols for Voice over Internet Protocol (VoIP) or Voice Over Packet (VOP) virtual conference event operations. It may be appreciated that other signaling protocols may be implemented for the virtual conference server 130, however, and still fall within the scope of the embodiments.

Regardless of the specific communications protocols and standards used for a given implementation, the virtual conference server 130 may include several types of multipoint control units (MCUs). One MCU may be an AV MCU 134 used to process and distribute audio-visual (AV) signals among the meeting consoles 110-1-m. For example, the AV MCU 134 may process and distribute video images and/or sound from the participants involved in the virtual conference event. Another MCU may be a data MCU 136 used to process and distribute data signals among the meeting consoles 110-1-m. For example, the data MCU 136 may process and distribute application data such as a slide deck for a presentation application program.

In general operation, virtual conference system 100 may be used for virtual conference events. Virtual conference events typically involve communicating voice, video, and/or data information between multiple end points. For example, a public or private packet network 120 may be used for audio conferencing calls, video conferencing calls, audio/video conferencing calls, collaborative document sharing and editing, and so forth. The packet network 120 may also be connected to a Public Switched Telephone Network (PSTN) via one or more suitable VoIP gateways arranged to convert between circuit-switched information and packet information.

To establish a virtual conference event over the packet network 120, each meeting console 110-1-m may connect to virtual conference server 130 via the packet network 120 using various types of wired or wireless communications links operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, the virtual conference server 130 may establish, manage and control a virtual conference event between meeting consoles 110-1-m. The virtual conference server 130 operates as a central server that controls and distributes media information in the conference. It receives media information from various meeting consoles 110-1-m, performs mixing operations for the multiple types of media information, and forwards the media information to some or all of the other participants. One or more of the meeting consoles 110-1-m may join a conference by connecting to the virtual conference server 130. The virtual conference server 130 may implement various admission control techniques to authenticate and add meeting consoles 110-1-m in a secure and controlled manner.

In various embodiments, the virtual conference system 100 may include one or more devices implemented as meeting consoles 110-1-m to connect to the virtual conference server 130 over one or more communications connections via the network 120. For example, a computing device may implement a client application that may host multiple meeting consoles each representing a separate conference at the same time. Similarly, the client application may receive multiple audio, video and data streams.

The meeting consoles 110-1-m may comprise any logical or physical entity that is arranged to participate or engage in a virtual conference event managed by the virtual conference server 130. The meeting consoles 110-1-m may be implemented as any device that includes, in its most basic form, a processing system including a processor and memory, one or more virtual input/output (I/O) components, and a wireless and/or wired network connection. Examples of virtual I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the meeting consoles 110-1-m may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, the meeting consoles 110-1-m may be implemented using a general or specific computing architecture similar to the computing architecture described with reference to FIG. 5.

The meeting consoles 110-1-m may comprise or implement respective client meeting components 112-1-n. The client meeting components 112-1-n may be designed to interoperate with the server meeting component 132 of the virtual conference server 130 to establish, manage or control a virtual conference event. For example, the client meeting components 112-1-n may comprise or implement the appropriate application programs and user interface controls to allow the respective meeting consoles 110-1-m to participate in a web conference facilitated by the virtual conference server 130. This may include input equipment (e.g., video camera, microphone, keyboard, mouse, controller, etc.) to capture media information provided by the operator of a meeting console 110-1-m, and output equipment (e.g., display, speaker, etc.) to reproduce media information by the operators of other meeting consoles 110-1-m. Examples for client meeting components 112-1-n may include without limitation a MICROSOFT OFFICE COMMUNICATOR or the MICROSOFT OFFICE LIVE MEETING Windows Based Meeting Console, and so forth.

The meeting consoles 110-1-m and the virtual conference server 130 may communicate media information and control information utilizing various media connections established for a given virtual conference event. The media connections may be established using various VoIP signaling protocols, such as the SIP series of protocols. The SIP series of protocols are application-layer control (signaling) protocol for creating, modifying and terminating sessions with one or more participants. These sessions include Internet virtual conferences, Internet telephone calls and virtual distribution. Members in a session can communicate via multicast or via a mesh of unicast relations, or a combination of these. SIP is designed as part of the overall IETF virtual data and control architecture currently incorporating protocols such as the resource reservation protocol (RSVP) (IEEE RFC 2205) for reserving network resources, the real-time transport protocol (RTP) (IEEE RFC 1889) for transporting real-time data and providing Quality-of-Service (QOS) feedback, the real-time streaming protocol (RTSP) (IEEE RFC 2326) for controlling delivery of streaming media, the session announcement protocol (SAP) for advertising virtual sessions via multicast, the session description protocol (SDP) (IEEE RFC 2327) for describing virtual sessions, and others. For example, the meeting consoles 110-1-m may use SIP as a signaling channel to setup the media connections, and RTP as a media channel to transport media information over the media connections.

In general operation, a schedule device 170 may be used to generate a virtual conference event reservation for the virtual conference system 100. The scheduling device 170 may comprise, for example, a computing device having the appropriate hardware and software for scheduling virtual conference events. For example, the scheduling device 170 may comprise a computer utilizing MICROSOFT OFFICE OUTLOOK® application software, made by Microsoft Corporation, Redmond, Wash. The MICROSOFT OFFICE OUTLOOK application software comprises messaging and collaboration client software that may be used to schedule a virtual conference event. An operator may use MICROSOFT OFFICE OUTLOOK to convert a schedule request to a MICROSOFT OFFICE LIVE MEETING event that is sent to a list of meeting invitees. The schedule request may include a link to a virtual conferences room for a virtual conference event. An invitee may click on the link, and the meeting console 110-1-m may connect to the virtual conference server 130, and join the virtual conference room. Once there, the participants can interact.

An operator may use the scheduling device 170 to generate a virtual conference event reservation for a virtual conference event. The virtual conference event reservation may include a list of meeting invitees for the virtual conference event. The meeting invitee list may comprise a list of individuals invited to a virtual conference event. In some cases, the meeting invitee list may only include those individuals invited and accepted for the virtual event. A client application, such as a mail client for Microsoft Outlook, forwards the reservation request to the virtual conference server 130. The virtual conference server 130 may receive the virtual conference event reservation, and retrieve the list of meeting invitees and associated information for the meeting invitees from a network device, such as an enterprise resource directory 160. Embodiments may also provide spontaneous virtual conferencing capabilities without scheduling an event in advance.

The enterprise resource directory 160 may comprise a network device that publishes a public directory of operators and/or network resources. A common example of network resources published by the enterprise resource directory 160 includes network printers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply important updates to an organization. Active Directory stores information and settings in a central database. Active Directory networks can vary from a small installation with a few hundred objects, to a large installation with millions of objects.

In various embodiments, the enterprise resource directory 160 may include identifying information for the various meeting invitees to a virtual conference event. The identifying information may include any type of information capable of uniquely identifying each of the meeting invitees. For example, the identifying information may include without limitation a name, a location, contact information, account numbers, professional information, organizational information (e.g., a title), personal information, connection information, presence information, a network address, a media access control (MAC) address, an Internet Protocol (IP) address, a telephone number, an email address, a protocol address (e.g., SIP address), equipment identifiers, hardware configurations, software configurations, wired interfaces, wireless interfaces, supported protocols, presence information, and other desired information.

In an embodiment, virtual conference server 130 may also include a profile component 138. Profile component 138 may create and maintain virtual conference (VC) user profiles 140-1-j for users registered to use virtual conference system 100. A VC user profile 140 may include a conference bridge 142 and other profile information 144. Conference bridge 140 may be specific to a user, referred to herein as the bridge owner, and may be essentially static, regardless of a user's physical location. Conference bridge 140 may include a dial-in telephone number, a uniform resource locator (URL) or other information that allows a conferee to access virtual conference system 100. Conference bridge 140 may further include an access code, a user ID, a pass code, or other information that allows a conferee to access a specific virtual conference room 150.

Other profile information 144 may include, but is not limited to, telephone numbers, e-mail addresses, mailing addresses, office locations, position in an organization, group memberships, and other information about a user. In an embodiment, a VC user profile 140 may contain some or all of the identifying information in an Active Directory profile. The Active Directory profile may be used as a VC user profile, with the addition of conference bridge 142. In an embodiment, a VC user profile 140 may be access controlled, so that VC users may only access user profiles that they are authorized to see.

The virtual conference server 130 may receive the virtual conference event reservation, including the list of meeting invitees, and retrieves the corresponding identifying information from the enterprise resource directory 160. The virtual conference server 130 may use the list of meeting invitees and corresponding identifying information to assist in identifying the participants to a virtual conference event. The virtual conference server 130 may also store and use the identifying information for implementing various recording management techniques.

Once a virtual conference event is initiated, the one or more meeting consoles 110-1-m may receive media content such as audio/visual (A/V) data from any local media source (e.g., a camera and/or microphone) and can send this media content over the network 120. In one embodiment, there is a distributed object (DO) layer which abstracts signaling stack transactions between the meeting consoles 110-1-m and the virtual conference server 130. Similarly, conference control and media transactions between the meeting consoles 110-1-m and the virtual conference server 130 may be abstracted, as will be known by those skilled in the art. The meeting components 112 may be operative for setting up and executing a web meeting, which includes sending and receiving meeting data, such as video and audio media content. Various user interface (UI) control modules may be implemented by the client meeting components 112-1-n at the meeting consoles 110-1-m to allow set up, control and display operations of the system and data. The client meeting components 112-1-n can also process integrated audio such as VOIP signals and PSTN signals.

In an embodiment, virtual conference system 100 may provide a permanent virtual conference “room” 150 unique to each user of the system. No setup or reservation may be required to use virtual conference room 150. Virtual conference system 100 may provide a “one-click” link, a button, or a touch pad selection to allow easy access to a bridge owner's virtual conference room such that neither the user nor conferees need to remember or provide dial-in numbers, pass codes, etc.

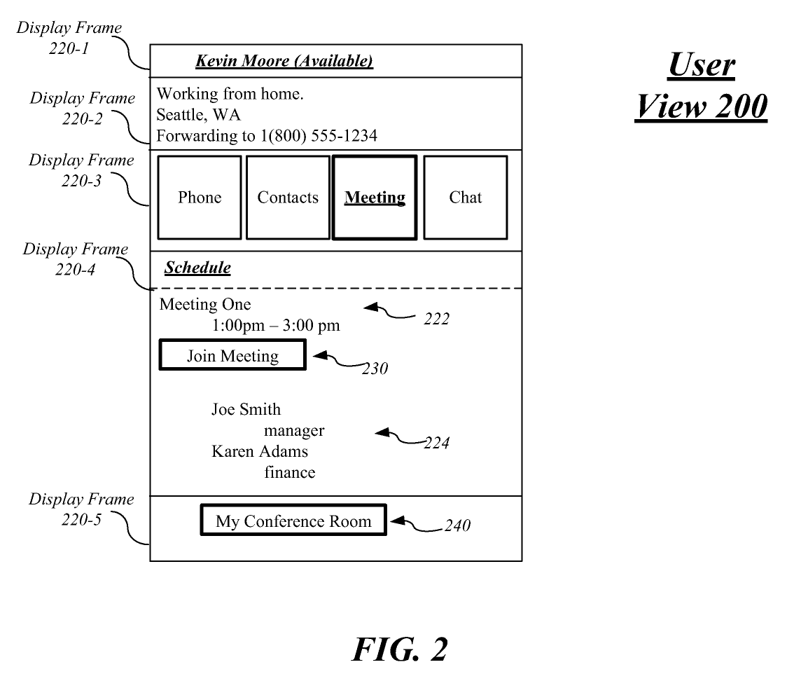

FIG. 2 illustrates an embodiment of a user view 200. User view 200 may be provided by a client meeting component 112. User view 200 may display components of a VA user profile 140 and provide one or more ways to access a virtual conference. User view 200 may include one or more display frames 220. For example, display frame 220-1 may display the user's name and current availability status. Display frame 220-2 may provide additional information about the user, such as, but not limited to, a current location, primary work site, and telephone information. Display frame 220-3 may provide selectable buttons to access various components of the VC user profile. The selected button may dictate the contents of display frame 220-4.

In FIG. 2, the Meeting button is selected in display frame 220-3. Display frame 220-4 displays information about the user's schedule. The user's schedule information may be provided by scheduling device 170. For example, the user has a meeting 222 scheduled, and the meeting 222 has invitees 224. Display frame 220-4 may provide a join meeting button 230, which may allow the viewer of user view 200 to join the meeting by clicking or selecting the button. Selecting join meeting button 230 may dial-in (if via PTSN) or open a URL (if via VOIP) to the virtual conference room for the meeting. The meeting organizer may be the bridge owner, and the virtual conference room for the meeting may be accessed via the bridge owner's conference bridge. The embodiments are not limited in this context.

Display frame 220-5 may provide a “my conference room” button 240. Button 240 may allow the viewer of user view 200 to enter the virtual conference room associated with the user in the display, in this example, Kevin Moore's virtual conference room. Note that for both button 230 and button 240, there is no need for the user to know or retrieve any dial-in or URL information. Further, there is no need to schedule a virtual conference in advance, as the virtual conference room is generally always available.

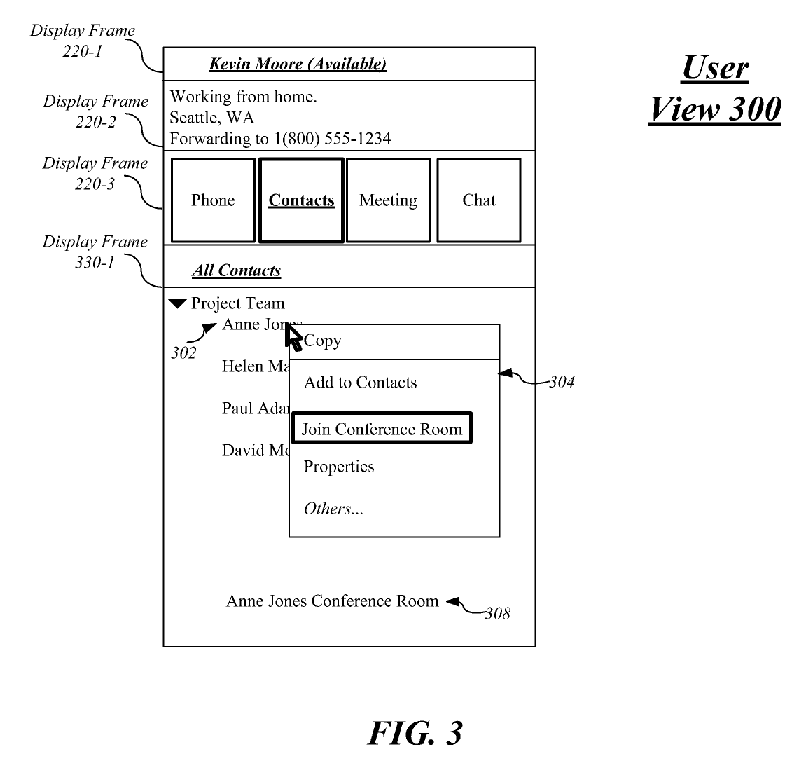

FIG. 3 illustrates an embodiment of a user view 300. User view 300 may be the same as, or analogous to, user view 200, but with a different button selected in display frame 220-3. User view 300 may also provide one or more ways to access a virtual conference room.

In FIG. 3, the Contacts button is selected in display frame 220-3. A list of contacts may be displayed in display frame 330-1. A contact may be selected, for example, by hovering the mouse pointer over a contact, clicking on a contact, alternate-clicking on a contact, etc. Selecting a contact, e.g. contact 302, may open a menu 304. Menu 304 may provide contact-related functions, including a “join conference room” function 306. Selecting join conference room 306 may place the selecting user into the virtual conference room associated with the selected contact, e.g. into Anne Jones' virtual conference room. The embodiments are not limited in this context.

Embodiments may display the link to a user's virtual conference room as a separate contact in a contact list. In display frame 330-1, for example, may display the link to Anne Jones' virtual conference room as item 308 in the contact list. On a telephone display, the link may be displayed as a contact in a displayed phone address book. The embodiments are not limited in this context.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

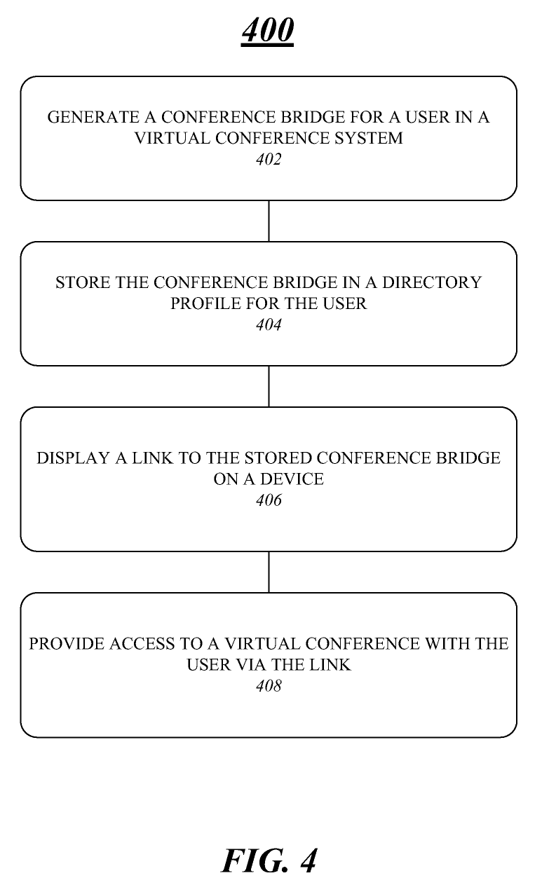

FIG. 4 illustrates one embodiment of a logic flow 400. Logic flow 400 may be representative of some or all of the operations executed by one or more embodiments described herein.

As shown in FIG. 4, the logic flow 400 may generate a conference bridge for a user in a virtual conference system, in block 402. For example, virtual conference server 130 may create a conference bridge 142 for a user when a user object is created, or when the user first logs into the system 100. The embodiments are not limited in this context.

Logic flow 400 may store the conference bridge, in block 404. The conference bridge may be stored, for example, in a directory profile for the user. The conference bridge may be stored, for example, in user profile 140. The stored conference bridge may then be available for use at any time to hold a virtual conference with the bridge owner. In addition, or alternatively, the conference bridge may be stored in a contact list or phone book entry for the user.

In an embodiment, the conference bridge may be stored in an access controlled container of a document that carries user profile information, e.g. in a Presence document container. Storing the conference bridge in an access controlled container may limit access to the conference bridge only to others who can access the Presence document. Other access-control techniques may be used to limit access to the conference bridge.

Logic flow 400 may display a link to the stored conference bridge on a device in block 406. A device may include one or more meeting consoles 110. For example, the link may be displayed as a button, such as buttons 230 or 240. The link may appear as a menu option on a user interface, such as menu function 306. The link may appear as a selection on a telephone display, for example, as part of a contact display. The link may be displayed as a URL, for example, in an email message or signature, or as part of a meeting event displayed in a calendar or scheduling application. The embodiments are not limited in this context.

It is worthwhile to note that virtual conference room information may be pushed to users of the VC system, for example, into a contact list on devices and/or soft phones where the conference bridge may be accessible via one “click.” In this way, a user may not have to look around to find this information. The virtual conference room information may be generally available on their phone or other communication devices.

In an embodiment, the link display may be limited by access restrictions. For example, if the conference bridge is stored in an access controlled Presence document container, only users with access to the Presence document may be able to see and/or use the link.

Logic flow 400 may provide access to a virtual conference with the user, i.e. the bridge owner, via the link, in block 408. In an embodiment, the link may be mapped to a button, touch screen segment, or other input mechanism, for example, on a telephone. When the link is selected, the selection may cause the virtual conference server 130 to open the bridge owner's virtual conference room 150. Link selection may cause a dial-in sequence to occur, e.g. over a PSTN, or may open a URL, e.g. in a VOIP network. The embodiments are not limited in this context.

FIG. 5 further illustrates a more detailed block diagram of computing architecture 510 suitable for implementing the meeting consoles 110-1-m or the virtual conference server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536-1-t and accompanying data. Depending on the implementation, examples of application programs 536-1-t may include the client meeting component 112, the server meeting component 132, profile component 138, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

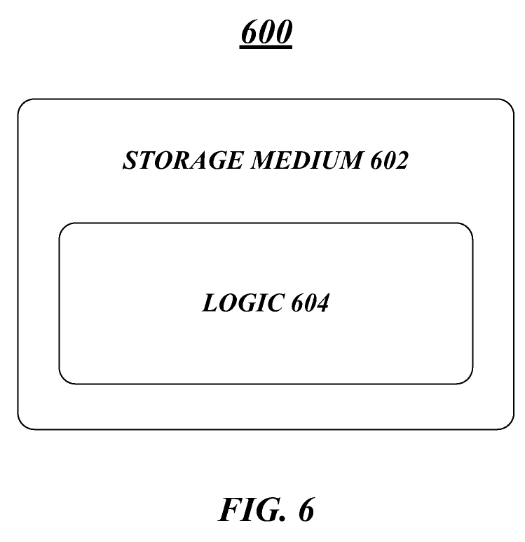

FIG. 6 illustrates a diagram an article of manufacture 600 suitable for storing logic for the various embodiments, including the logic flow 400. As shown, the article of manufacture 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article of manufacture 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An article comprising a storage medium containing instructions that if executed enable a system to:
generate a conference bridge for a bridge owner in a virtual conference system;
store the conference bridge in a directory profile for the bridge owner;
display a link to the stored conference bridge on a device; and
provide access to a virtual conference with the bridge owner via the link.

2. The article of claim 1, further comprising instructions that if executed enable the system to provide the link in at least one of: a meeting event, an email message, a contact record, or a directory profile display.

3. The article of claim 1, further comprising instructions that if executed enable the system to generate the conference bridge comprising at least one of an access telephone number, an access code, or a pass code.

4. The article of claim 3, further comprising instructions that if executed enable the system to generate a uniform resource locator (URL), or generate a dialing sequence.

5. The article of claim 1, further comprising instructions that if executed enable the system to display the link on at least one of a computer, a personal digital assistant, a wireless telephone or a wired telephone.

6. The article of claim 1, further comprising instruction that if executed enable the system to:
apply an access control setting to the conference bridge; and
display the link to the access-controlled conference bridge only to users having access control privileges that allow access to the access-controlled conference bridge.

7. A method, comprising:
generating a conference bridge for a bridge owner in a virtual conference system;
storing the conference bridge in a directory profile for the bridge owner;
displaying a link to the stored conference bridge on a device; and
providing access to a virtual conference with the bridge owner via the link.

8. The method of claim 7, comprising:
providing the link in at least one of: a meeting event, an email message, a contact
record, or a directory profile display.

9. The method of claim 7, comprising:
generating the conference bridge comprising at least one of an access telephone number, an access code, or a pass code.

10. The method of claim 9, wherein generating the conference bridge comprises at least one of:
generating a uniform resource locator (URL), or
generating a dialing sequence.

11. The method of claim 7, comprising.
receiving a selection of the link by a selecting user; and
placing the selecting user into a virtual conference with the bridge owner via the conference bridge associated with the link.

12. The method of claim 11, wherein the selecting user is the bridge owner.

13. The method of claim 11, wherein the selecting user is not the bridge owner.

14. The method of claim 11, wherein receiving the selection of the link comprises at least one of:
receiving a selection of a URL;
receiving a selection of a button;
receiving a selection of a menu item; or
receiving a selection of a user interface element.

15. An apparatus, comprising:
a virtual conference (VC) server component operative to:
generate a conference bridge for a bridge owner;
provide a link to the conference bridge; and
provide access to a virtual conference with the bridge owner via the link,
the VC server component comprising:
a profile module operative to store the conference bridge in a directory profile for the bridge owner; and
a server meeting module operative to create a virtual conference with the bridge owner when the link is accessed.

16. The apparatus of claim 15, the VC server component operative to provide the link in at least one of: a meeting event, an email message, a contact record, or a directory profile display.

17. The apparatus of claim 15, the VC server component operative to generate the conference bridge comprising at least one of an access telephone number, an access code, or a pass code.

18. The apparatus of claim 15, the VC server component operative to generate a uniform resource locator (URL), or generate a dialing sequence.

19. The apparatus of claim 15, comprising a meeting console operative to display the link.

20. The apparatus of claim 19, the meeting console operative to receive a selection of the link by a selecting user; and
place the selecting user into a virtual conference with the bridge owner via the conference bridge associated with the link.

21. The apparatus of claim 20, the meeting console operative to receive a selection of at least one of:
a URL;
a button;
a menu item; or
a user interface element.

22. The apparatus of claim 19, the meeting console operative to retrieve the link from a scheduled event and to display the link.
